(19) United States
(12) Patent Application Publication
(10) Pub. No.: US 2001/0022984 A1
(43) Pub. Date: Sep. 20, 2001

(54) PREPARATION OF A DOUGH FOR OBTAINING A PUFF PASTRY-TYPE PRODUCT

(76) Inventors: FABIANA FERRARI-PHILIPPE, BEAUVAIS (FR); GINETTE HARLAUX, BEAUVAIS (FR); SYLVIE PENET, WARLUIS (FR)

Correspondence Address: ALLAN A. FANUCCI ESQ., WINSTON & STRAWN, 200 PARK AVENUE, NEW YORK, NY, 10166, US

(21) Appl. No.: 09/297,875

(22) PCT Filed: Nov. 10, 1997
(86) PCT No.: PCT/EP97/06255

§ 371 Date: None

(30) Foreign Application Priority Data
Nov. 11, 1996 (EP) 96203110.0

(51) Int. Cl. A21D 6/00

(52) U.S. Cl. 426/94; 426/549; 426/496

(57) ABSTRACT

Process for the preparation of a puff pastry, in which a composition containing flour, salt, acidic proteins and an inactivated fermentation agent is mixed at room temperature, lumps of fat are added to this composition during the mixing step so as to obtain a heterogeneous dough, finally water is incorporated into this dough, the dough is extruded and then the puff pastry thus obtained is stored at a temperature of −40° C. to +10° C.

The subject of the present invention is a process for the preparation of a puff pastry.

It is known that, traditionally, the preparation of a well-aerated and light puff pastry involves a delicate and relatively long operation.

J. L. Kiger et al. [Techniques modernes de la biscuiterie, pâtisserie—boulangerie industrielles et artisanales et des produits de régime] (Modern techniques in industrial and small-scale biscuit, pastry and bakery product production and in dietetic product production—volume 1, p. 347-348, DUNOD series, 1968) describe a preparation of puff pastry consisting of a succession of foldings and rollings, that is to say a succession of folding of the dough over on itself, so as to obtain sheeting consisting of a superposition of sheets of fat and of sheets of dough. The document describes a preparation in which the plastic fat and the flour are equal in weight and the quantity of water is equivalent to half the weight of flour. The water and the flour are mixed into a homogeneous paste which, after a 10-15 min rest, is laminated into a square sheet in the middle of which the plastic fat, butter, is placed in small lumps. The butter is trapped in the dough by folding the edges of the sheet, so as to obtain a sheet of butter between two sheets of dough. After a rest of 15 min, the dough is laminated into a long thin band which is then folded over on itself into 3 pieces of equal length in order to obtain a sheeting consisting of 3 layers of butter separated by 2 layers of dough. Next, 6 successive foldings and rollings, separated by resting times of 15 min during which the dough is covered with a wet cloth in order to avoid crust formation, are carried out in order to obtain a puff pastry consisting of 729 sheets of butter separated by layers of dough. After baking, the pastry thus has an aerated and light sheeting.

Moreover, UK 2070408 describes the preparation of a puff pastry in which the flour, water, salt and fat lumps are mixed together so as to obtain a heterogeneous dough having lumps of fat. This dough is laminated and placed in a cool place before being cut into a large number of laminations, preferably 0.25 mm to 3 mm thick, which are then agglomerated together so as to produce a heterogeneous dough having lumps of fat and consisting of a superposition of sheets. Next, the puff pastry thus produced is laminated into a dough 5 to 6 mm thick and is used for the production of food products.

The object of the present invention is to provide a process for the preparation of a puff pastry having physical properties and organoleptic qualities similar to those of traditional puff pastries.

To this effect, in the process for the preparation of a puff pastry according to the present invention, a composition containing, for 1 kg of flour, 16-24 g of salt, 7-13 g of acidic proteins and 19-21 g of inactivated fermentation agent is mixed at room temperature, 320-480 g of lumps of fat are added to this composition during the mixing step so as to obtain a heterogeneous dough, finally 450-550 g of water are incorporated into this dough at room temperature, the dough is extruded so as to compress the lumps of fat and to obtain a puff pastry and then this puff pastry is stored at a temperature of −40° C. to +10° C.

It has been observed, surprisingly, that the process for the preparation of the puff pastry according to the invention, although not having a succession of folding and rolling steps, makes it possible to produce, under conditions which are simple and quick to implement, a dough having an aerated and light sheeting. Furthermore, this process makes it possible to produce a puff pastry having a better moisture retention than that of a puff pastry obtained by a traditional process. Finally, the puff pastry obtained using the process according to the present invention can be stored at low temperatures and can in particular be microwave heated while retaining a well-aerated and light puff texture.

In the remainder of the description, the expression “prepared meal” will be used to designate in particular snacks or side dishes.

Finally, in the remainder of the description, the expression “lactic yeast” will be used to designate yeasts of the Saccharomyces kluyveromyces lactis type or yeasts of the Saccharomyces kluyveromyces fragilis type which have grown on a lactic culture medium, such as defatted and deproteinized milk.

In the process for the preparation of the puff pastry according to the present invention, the mixing step can be carried out in a blade-type mill for 20 s to 1 min at 5-13 rpm, for example. It is possible to use in particular the blade-type mill marketed by Maschinen Fabrik Laska, GES M.B.H, Markstrasse 60, AU-4050 TRAUN.

Mixing is therefore carried out at room temperature of a composition containing, for 1 kg of flour, 16-24 g of salt, 7-13 g of acidic proteins and 19-21 g of inactivated fermentation agent.

The flour is preferably soft wheat flour whose gluten content is 7-13%, so as to obtain a dough having a smooth texture.

The acidic proteins are preferably milk proteins. They give a better extensibility to the dough, especially during the lamination of the dough, by reducing the hardness of the dough and they play a role in the colour of the dough during its baking and its reheating.

The inactivated fermentation agent is preferably a heat-inactivated bakers' yeast or a heat-inactivated lactic yeast. It is intended to promote the formation of a more aerated texture of the dough by enhancing the elasticity and the sheeting of the dough. Indeed, it acts on the gluten disulphide bridges, allowing better absorption of water and better relaxation of the gluten and thus avoids obtaining a rubbery texture and substantial drying of the dough during microwave heating.

The inactivated fermentation agent is therefore a bakers' yeast or lactic yeast which are inactivated by a sufficient heat treatment which stops the fermentation activity, and which are then spray-dried. It may be in particular the heat-inactivated bakers' yeast marketed by Gist-Brocades N.V., Food Ingredient division, P.B. 01, NL-260, MA DELFT or by Fould Springer, 103 rue Jean Jaures, F-94701 MAISON ALFORD or the heat-inactivated lactic yeast marketed by Fromagerie Bel, 8 rue Penthièvre, F-75008 PARIS, for example.

320-480 g of lumps of fat are therefore added to this composition, during the mixing step, so as to obtain a heterogeneous dough. The fat may be puff pastry margarine, for example.

Finally, 450-550 g of water at room temperature are incorporated into this dough.

The dough is then extruded so as to compress the lumps of fat and to obtain a puff pastry. It can be extruded in a twin-screw extruder marketed by Rijkaart Maschinen Fabrik, NL-4147 CT Asperen, for example.

Next, the puff pastry thus produced is then stored at a temperature of −40° C. to +10° C. It can be stored in the refrigerator or the freezer or it can be deep-frozen, for example.

The puff pastry can be baked before or after the storage step, for example. It can be divided into dough pieces of 20-500 g, before baking it, for example. It can be baked in a conventional oven at 190-250° C. for 10-45 min or in a band baking machine at 190-225° C. for 2-10 min, for example.

The puff pastry is then preferably microwave heated for 20 s to 10 min, after the baking step followed by the storage step or after the storage step followed by the baking step, so as to obtain a puff pastry ready for consumption and having a light and well-aerated sheeting. It is also possible to heat it in a conventional oven at 150-220° C., for example.

The dough thus produced can also be consumed without heating it beforehand, for example.

It is possible, before or after the storage step, to laminate or to give a base to the puff pastry, to place on the band or on the puff pastry base meat or fish pieces, a sauce, vegetables or fruit whole and/or in pieces, cheese, spices and/or cereals and to carry out the baking step.

If it is desired to prepare a savoury prepared meal, it is possible to place, on the band or on the dough base according to the invention, meat or fish pieces, a sauce, whole vegetables and/or vegetable pieces, cheese, spices and/or cereals, for example.

The meat may be beef, chicken, turkey, veal, pork or prepared meat products such as ham, sausage or salami, for example.

The fish may be cod, salmon, sole or hake, for example.

It is possible to add precooked or raw meat or fish pieces, for example. It is also possible to add meat or fish in sauce, for example.

The whole vegetables and/or vegetable pieces may be tomatoes, sweet peppers, mushrooms, sweetcorn, onions, carrots, peas, celery, beans, potatoes or broccoli, for example.

It is possible to blanch or precook the whole vegetables and/or vegetable pieces before adding them to the dough, for example. It is also possible to add them in puree form, for example.

The cheese may be gruyere, mozzarella, cheddar or emmenthal, for example.

The sauce may be mustard, ketchup, tomato sauce or a white sauce, for example.

The cereals may be polished rice or pearl barley which may be precooked or sesame or poppy, for example.

The spices may be pepper, rosemary, sage, ginger, thyme, chilli or cumin, for example.

If it is desired to prepare a sweet prepared meal, it is possible to place, on the band or at the bottom of the dough according to the invention, whole fruit and/or fruit pieces, a sauce, spices and/or cereals, for example.

The fruit may be apple, pear, cherry, pineapple or apricot, for example.

The sauce may be a vanilla sauce, a caramel sauce or a chocolate sauce, for example.

The spices may be cinnamon or vanilla, for example.

The cereals may be polished rice or pearl barley which may be precooked, for example.

The subject of the present invention is also a prepared meal obtained using the present process.

The process according to the present invention is described in greater detail in the nonlimiting examples below. In these examples, the percentages and parts are given by weight, unless otherwise stated.

### EXAMPLE 1

Using the process according to the present invention, a puff pastry product containing mushrooms and poultry is prepared.

To do this, a composition containing 28 g of soft wheat flour, 0.6 g of salt, 0.3 g of acidic proteins and 0.6 g of heat-inactivated yeast is mixed at room temperature. This mixing step is carried out in a blade-type mill marketed by Maschinen Fabrik Laska, GES M.B.H, Markstrasse 60, AU-4050 TRAUN.

During the mixing of the composition, 11.4 g of lump puff pastry margarine are added so as to obtain a heterogeneous dough. Next, 14.3 g of water are incorporated into the dough.

The puff pastry thus produced is then extruded in a twin-screw extruder marketed by Rijkaart Maschinen Fabrik, NL-4147 CT Asperen.

In parallel, a mushroom and poultry filling is prepared. To do this, a sauce is prepared from 0.76 g of sunflower oil, 3.8 g of onion slices, 0.04 g of fine salt, 0.004 g of dry garlic, 0.008 g of bay leaves, 0.004 g of thyme and 0.008 g of black pepper. 2.67 g of this sauce is then mixed with 2.67 g of thinly sliced cultivated mushrooms, 2.67 g of cooked turkey meat, 0.67 g of deep-frozen blanched fine peas and 1.34 g of grated raclette cheese.

A base is then given to the puff pastry and the mushroom and poultry filling thus prepared is placed on the dough base.

The puff pastry product containing mushrooms and poultry is then baked in a conventional oven at 200° C. for 18 min.

It is then stored at −40° C.

The consumer can thus place the puff pastry product containing mushrooms and poultry in a dish and heat it in a microwave oven for 3 min without the puff pastry losing its light and aerated texture.

The puff pastry product thus heated has a golden appearance and a crunchy texture at the surface, a well-aerated texture inside and a taste and flavour which are similar to traditional puff pastry products.

### EXAMPLE 2

A puff pastry product containing scrambled eggs is prepared.

To do this, the process is carried out as described in Example 1, except that a scrambled egg filling is placed on the dough base.

Scrambled egg is then prepared from a sauce containing 2.2 g of water, 0.3 g of maize starch, 0.07 g of poultry broth, 0.005 g of black pepper, 0.005 g of nutmeg, 0.005 g of aromatic yellow plant extract and 2.5 g of pasteurized crème fraîche. This sauce is mixed with 2 g of omelette pieces, 2 g of cooked and smoked pork shoulder and 1 g of grated raclette cheese.

A base is then given to the puff pastry which has been previously prepared and the scrambled egg filling is placed on the dough base.

The puff pastry product containing scrambled eggs is then baked in a conventional oven at 200° C. for 18 min.

It is then stored at −40° C.

The consumer can thus place the puff pastry product containing scrambled eggs in a dish and heat it in a microwave oven for 3 min without the puff pastry losing its light and aerated texture.

The puff pastry product thus heated has a golden appearance and a crunchy texture at the surface, a well-aerated texture inside and a taste and flavour which are similar to traditional puff pastry products.

1. Process for the preparation of a puff pastry, in which:
a composition containing, for 1 kg of flour, 16-24 g of salt, 7-13 g of acidic proteins and 19-21 g of inactivated fermentation agent is mixed at room temperature,
320-480 g of lumps of fat are added to this composition during the mixing step so as to obtain a heterogeneous dough,
finally 450-550 g of water at room temperature are incorporated into this dough,
the dough is extruded so as to compress the lumps of fat and to obtain a puff pastry,
the puff pastry thus obtained is then stored at a temperature of −40° C. to +10° C.

2. Process according to claim 1, in which the mixing step is carried out in a blade-type mill for 20 s to 1 min at 5-13 rpm.

3. Process according to claim 1, in which the puff pastry is baked before or after the storage step.

4. Process according to claim 3, in which the puff pastry is heated in a microwave oven.

5. Process according to claim 1, in which the inactivated fermentation agent is a heat-inactivated bakers' yeast or a heat-inactivated lactic yeast.

6. Process according to claim 1, in which, before or after the storage step, the puff pastry is laminated or given a base, meat or fish pieces, a sauce, vegetables or fruit whole and/or in pieces, cheese, spices and/or cereals are placed on the band or on the puff pastry base and a baking step is carried out.

7. Prepared meal obtained using the process according to one of claims 1 to 6.
